(19) United States
(12) Patent Application Publication
(10) Pub. No.: US 2023/0331996 A1
(43) Pub. Date: Oct. 19, 2023

(54) METHOD OF COATING METAL STRUCTURAL MEMBER TO RESIST CORROSION, COMPOSITION OF COATING, AND STRUCTURAL MEMBER INCLUDING COATING

(71) Applicant: Sheet Pile LLC, Holderness, NH (US)

(72) Inventor: Sameerkumar Vasantlal Patel, Raleigh, NC (US)

(21) Appl. No.: 17/722,840

(22) Filed: Apr. 18, 2022

(51) Int. Cl. C09D 1/00; C09D 7/61; C23C 22/78; C09D 7/45; C09D 7/65; C09D 5/08; C09D 7/43; C23C 22/22

(52) U.S. Cl. CPC C09D 5/084; C09D 1/00; C09D 7/43; C09D 7/45; C09D 7/61; C09D 7/65; C23C 22/22; C23C 22/78

(57) ABSTRACT

A structural member may include a primary metal member having a metal surface containing iron, the metal surface susceptible to corrosion, and a protective outer coating formed on the metal surface to resist corrosion. The coating may include a polyaspartic top coat layer and a passivation layer. The coating may be formed of a first part including an inorganic acid phosphate mixture and a second part including an inorganic alkaline metal oxide or hydroxide mixture. The first part may include an inorganic acid phosphate mixture having acidic phosphate component, filler, water as solvent, suspension agent, and nonionic surfactant. The second part may include an inorganic alkaline metal oxide or hydroxide mixture having metal oxide or hydroxide, filler, water as solvent, suspension agent, and surfactant.

### REFERENCE TO RELATED APPLICATIONS

. This application on the date of filing is not related to any other application

### FIELD OF THE INVENTION

This disclosure relates to phosphate ceramic coatings that inhibit or resist corrosion of iron and steel, compositions of such coatings, structural members having such phosphate ceramic coatings, and methods of coating a phosphate cement precursor composition onto a structural member having previously prepared metallic surfaces.

### BACKGROUND

The corrosion of steel and other metals may cause major concerns in the construction and utility industries. When steel is exposed to humid and saline environments, especially at high temperature, it may weaken. Alloys of steel, such as galvanized compositions, or chrome plated compositions may be used to prevent corrosion. While these methods may help slow down the corrosion in the short term, over the long term they may not be effective. This disclosure relates to phosphate based composite coatings that may minimize, resist or reduce the corrosion of steel and other metals, which may remove the need for alloys of steel.

### SUMMARY OF THE INVENTION

In an embodiment, a coating method may include coating at least a portion of an iron surface susceptible to corrosion, providing corrosion protection thereto. In an embodiment, a coating system may include an inorganic phosphate mixture, and an inorganic alkaline metal oxide or hydroxide mixture. In an embodiment, a phosphate cement coating may be prepared from a precursor composition comprising at least one acid phosphate, and at least one metal oxide or hydroxide.

In an embodiment, a method may provide corrosion protection or resistance to at least a portion of a structural member having an iron surface susceptible to corrosion. Such structural member may include, for example, a structural metal profile. In an embodiment, such structural metal profile may include an elongated interlocking connection extending along one edge thereof substantially in entirety between opposite ends thereof. In an embodiment, such a structural metal profile may be a sheet pile configured to form an elongated interlocking connection along one edge thereof with an adjacent elongated interlocking connection of an adjacent structural metal profile. In an embodiment, a structural metal profile may be formed of steel conforming to ASTM A690, which includes higher copper content in comparison to other steel compositions.

In an embodiment, a method may comprise sandblasting a structural member to remove mill scale; cleaning with water pressure washing; drying with compressed air; applying a coating system; curing the iron surface with the coating system for more than 1 hour; inspecting the iron surface for defects; and, if a defect is found, repeating the sandblasting, cleaning, drying, applying, curing, and inspecting. In an embodiment, such method for coating may include curing to form a ceramic layer when acid phosphate reacts with alkaline oxide, and acid phosphate reacts with the iron surface, leading to the ceramic layer being chemically bonded to the iron surface.

In an embodiment, such method for coating may include curing to form a phosphate containing passivation layer chemically bound to the iron surface.

In an embodiment, such method for coating may include applying a polyaspartic top coat outer layer to the dry, coated iron surface.

### BRIEF DESCRIPTION OF THE DRAWINGS

FIG. 1 is a simplified schematic view of a coating structural member in an embodiment, illustrating aspects of self-healing an opening or defect in such coating. FIG. 2 is a simplified flow diagram showing a method of providing corrosion protection to a metal structural member susceptible to corrosion.

### DETAILED DESCRIPTION OF ILLUSTRATIVE EMBODIMENT

It is known that different alloys of steel corrode at very different rates. For example, an increase in copper content from 0.01% to 0.05% may reduce corrosion rates by half. Further, adding small amounts of nickel and chromium may also reduce rates of corrosion. However, alloying iron is expensive and may breach the integrity of the metal structure.

Disclosed herein is a novel alternative to alloying of exposed surfaces and regions just below the exposed surfaces of metals. In an embodiment, a phosphate ceramic coating may provide functionality similar to alloying techniques with many added advantages. Methods as described herein may result in alloying of outer exposed surface, and the regions just below the outer exposed surface of the bulk metal surface in a cost-effective manner. The methods described herein may also not substantially affect bulk properties of the metal. The methods and compositions described herein may provide a chemically bonded, alloyed surface zone, providing corrosion protection and also may provide the benefit of abrasion resistance. The methods and compositions described herein may also provide resistance to chemical agents, attack and undesired chemical reactions such as, for example, undesired oxidation or rusting.

In an embodiment, the alloying may be described as phosphating the iron surface with the metallic surface in combination with metals introduced from the acidic phosphate and/or basic component, forming a passivation layer that may be chemically associated with the metallic surface. In an embodiment, the passivation layer may be sandwiched between the metallic surface and a phosphate-based ceramic-like coating. In an embodiment, silicates may be included with the acidic phosphate and basic components, creating an insoluble passivation layer that may be amorphous and non-porous. In an embodiment, a suitable commercially available product is silica available from Evonik (Essen, Germany).

In an embodiment, a method may provide improved preparation of acidic phosphate components and basic components prior to combination so as to manage the chemical reaction and/or pH of the reactions. In an embodiment, a method may provide improved incorporation of silicates into passivation layers. In an embodiment, a suitable commercially available product is silica available from Evonik (Essen, Germany).

In an embodiment, acidic phosphates refer to inorganic phosphates of chemical formula Aₘ(H₂PO₄)ₘ-nH₂O in an aqueous solution, suspension, or slurry of an acid-phosphate, where A is a hydrogen ion, ammonium cation, metal cation, or mixtures thereof; where m = 1-3, and n = 0-6. In an embodiment, the first component solution may be adjusted to a pH of about 2 to about 5. In an embodiment, a basic component may comprise, for example, an aqueous solution, suspension, or slurry of an alkaline oxide or alkaline hydroxide. The formula may be, for example, MₙO or Mₙ(OH)ₙ, where n may be 1, 2, etc; and where M may be Ca, Mg, etc. The pH of this formula may be between about 9 to 14. In an embodiment, a rheology modifier/suspending agent in an amount capable of providing shear thinning of the first or second components, or both, may be included. In an embodiment, the rheology modifier/suspending agent may be a spray coating that provides a thin, paint-like coating for inducing corrosion prevention. In an embodiment, the rheology modifier/suspending agent may be at least one of guar gum, diutan gum, welan gum, and xanthan gum.

In an embodiment, the phrase “aqueous mixture” may refer to a combination of at least a quantity of water and at least one of the acid phosphate or basic components. In an embodiment, for example, the aqueous mixture may contain most water and suspended, dispersed, or slurried components, and may also contain non-aqueous components such alcohols and other solvents.

In an embodiment, the formulations and methods disclosed may be based, in an aspect, on acid-base inorganic phosphate compositions. In other embodiments, similar principles are applicable for other acid/base pair compositions other than inorganic phosphates. In embodiments, for example, the inorganic phosphate coatings include magnesium potassium phosphate coating, which optionally contains silicates chemically integrated therewith. These compositions, for example, are disclosed herein for coatings on steels, aluminums, and other corrodible metals as effective corrosion inhibitors.

In an embodiment, a coating system for coating at least a portion of an iron surface susceptible to corrosion, providing corrosion protection thereto, is provided. In an embodiment, the coating system may include an inorganic acid phosphate mixture comprising: at least one acidic phosphate component; at least one filler selected from metal silicates, olivine, glass fiber, non-crystalline silica, or wollastonite; water as a solvent; suspension agents such as gum, x-gum, or thickeners; and non-ionic surfactants, and an inorganic alkaline metal oxide or hydroxide mixture comprising: metal oxide or hydroxide; at least one filler selected from metal silicates, olivine, glass fiber, non-crystalline silica, or wollastonite; water as a solvent; suspension agents such as gum, x-gum, or thickeners; and surfactants such as polyacrylates. In an embodiment, a suitable commercially available product is x-gum available from R.T. Vanderbilt (Norwalk, Connecticut). In an embodiment, a suitable commercially available product is silica available from Evonik (Essen, Germany). In an embodiment, a suitable commercially available product is filler available from Lintech International (Macon, Georgia). In an embodiment, filler may include a suitable commercially available product, which is microglass milled fibers available from Fibertec, Inc. (Bridgewater, MA). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In embodiments, the inorganic acid phosphate mixture: inorganic alkaline metal oxide or hydroxide mixture may be combined in a ratio of 1:1. In embodiments, the inorganic acid phosphate mixture: inorganic alkaline metal oxide or hydroxide mixture may be combined in a ratio of 2:1. In embodiments, the inorganic acid phosphate mixture: inorganic alkaline metal oxide or hydroxide mixture may be combined in a ratio of 1:2. In embodiments, the concentration of the acid phosphate component in the inorganic acid phosphate mixture may be in the range 20-80%. In embodiments, the concentration of the metal oxide or hydroxide component in the inorganic alkaline metal oxide or hydroxide mixture may be in the range 20-80%.

In embodiments, a coating system for coating at least a portion of an iron surface susceptible to corrosion, providing corrosion protection thereto, is provided. In an embodiment, the coating system may include an inorganic acid phosphate mixture comprising: at least one acidic phosphate component; water as a solvent; suspension agents such as gum, x-gum, or thickeners; and non-ionic surfactants; inorganic alkaline metal oxide or hydroxide mixture comprising: metal oxide or hydroxide water as a solvent; suspension agents such as gum, x-gum, or thickeners; and surfactants such as polyacrylates. In an embodiment, a suitable commercially available product is x-gum, available from R.T. Vanderbilt (Norwalk, Connecticut). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2. In an embodiment, the concentration of the acid phosphate component in the inorganic acid phosphate mixture may be in the range 20-80%. In an embodiment, the concentration of the metal oxide or hydroxide component in the inorganic alkaline metal oxide or hydroxide mixture may be in the range 20-80%.

In an embodiment, a coating system for coating at least a portion of an iron surface susceptible to corrosion, providing corrosion protection thereto, is provided. In an embodiment, such coating system may include an inorganic acid phosphate mixture comprising: 40-60 % mono potassium phosphate; 1-8 % phosphoric acid; 8-20 % of at least one filler selected from metal silicates, olivine, glass fiber, non-crystalline silica, or wollastonite; 10-20 % water; inorganic alkaline metal oxide or hydroxide mixture comprising: 25-50 % magnesium oxide or hydroxide; 10-25 % of at least one filler selected from metal silicates, olivine, glass fiber, non-crystalline silica, or wollastonite; 10-30 % water; 0-1 % of at least one suspension agent such as gum, x-gum, or thickeners. In an embodiment, a suitable commercially available product is monopotassium phosphate available from ICL fertilizer (St. Louis, Missouri). In an embodiment, a suitable commercially available product is phosphoric acid available from ICL fertilizer (St. Louis, Missouri). In an embodiment, a suitable commercially available product is x-gum available from R.T. Vanderbilt (Norwalk, Connecticut). In an embodiment, a suitable commercially available product is silica available from Evonik (Essen, Germany). In an embodiment, a suitable commercially available product is magnesium hydroxide available from Timab (Dinard, France). In an embodiment, a suitable commercially available product is filler available from Lintech International (Macon, Georgia). In an embodiment, filler may include a suitable commercially available product, which is microglass milled fibers available from Fibertec, Inc. (Bridgewater, MA).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2.

In an embodiment, a coating system for coating at least a portion of an iron surface susceptible to corrosion, providing corrosion protection thereto, is provided. In an embodiment, a coating system may include an inorganic acid phosphate mixture comprising: 40-60 % mono potassium phosphate; 8-20 % of at least one filler selected from metal silicates, olivine, glass fiber, non-crystalline silica, or wollastonite; 10-20 % water; inorganic alkaline metal oxide or hydroxide mixture comprising: 25-50 % magnesium oxide or hydroxide; 0-5 % of at least one filler selected from metal silicates, olivine, glass fiber, non-crystalline silica; 10-20 % wollastonite; 10-30 % water; 0-2 % surfactants such as polyacrylates; 0-1 % suspension agents such as gum, x-gum, or thickeners. In an embodiment, a suitable commercially available product is x-gum, available from R.T. Vanderbilt (Norwalk, Connecticut). In an embodiment, a suitable commercially available product is monopotassium phosphate, available from ICL fertilizer (St. Louis, Missouri). In an embodiment, a suitable commercially available product is silica, available from Evonik (Essen, Germany). In an embodiment, a suitable commercially available product is magnesium hydroxide, available from Timab (Dinard, France). In an embodiment, a suitable commercially available product is filler available from Lintech International (Macon, Georgia). In an embodiment, filler may include a suitable commercially available product, which is microglass milled fibers available from Fibertec, Inc. (Bridgewater, MA). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2.

In an embodiment, a coating system for coating at least a portion of an iron surface susceptible to corrosion, providing corrosion protection thereto, is provided. In an embodiment, a coating system may include an inorganic acid phosphate mixture comprising: 5-15 % mono aluminum phosphate; 8-20 % of at least one filler selected from metal silicates, olivine, glass fiber, non-crystalline silica, or wollastonite; 10-20 % water; inorganic alkaline metal oxide or hydroxide mixture comprising: 25-50 % magnesium oxide or hydroxide; 0-5 % of at least one filler selected from metal silicates, olivine, glass fiber, non-crystalline silica; 10-20 % wollastonite; 10-30 % water; 0-2 % surfactants such as polyacrylates; 0-1 % suspension agents such as gum, x-gum, or thickeners. In an embodiment, a suitable commercially available product is x-gum, available from R.T. Vanderbilt (Norwalk, Connecticut). In an embodiment, a suitable commercially available product is silica, available from Evonik (Essen, Germany). In an embodiment, a suitable commercially available product is magnesium hydroxide, available from Timab (Dinard, France). In an embodiment, a suitable commercially available product is filler, available from Lintech International (Macon, Georgia). In an embodiment, filler may include a suitable commercially available product, which is microglass milled fibers available from Fibertec, Inc. (Bridgewater, MA). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2.

In an embodiment shown in FIG. 2, a method 400 of providing corrosion protection to at least a portion of metal structural member having an iron surface susceptible to corrosion, is disclosed. Such method 400 may include: preparing 410 the metal surface to a condition facilitating and enabling formation of the passivation layer on the metal surface. Such preparing 410 the metal surface may further include: removing 420 mill scale; cleaning 430 with water such as by pressure washing; and drying 440 with compressed air. Such method of providing corrosion protection may further include: applying 450 a coating system. Such method of providing corrosion protection may further include: curing 460 the iron surface with the coating system. In an embodiment, for example, such curing may include curing the iron surface with the coating system for more than about one (1) hour. Such method of providing corrosion protection may further include: inspecting 470 the iron surface for defects. Such method of providing corrosion protection may further include: if a defect is found, repeating 480 the sandblasting, cleaning, drying, applying, curing, and inspecting. Such repeating of the aforementioned may be discontinued when no defect is found by the inspecting. In an embodiment, such preparing the metal surface to a condition facilitating and enabling formation of the passivation layer on the metal surface may include: removing contaminants, particulates and scale that may interfere with formation of the passive layer in chemically bonded relationship with the metal surface. In an embodiment, the metal surface having mill scale (e.g. a mill scale surface) may be prepared by particulate blasting, such as sandblasting, chemical treatment, or both.

In an embodiment, the coasting system may include inorganic acid phosphate mixture comprising: at least one acidic phosphate component; water as a solvent; suspension agents such as gum, x-gum, or thickeners; and non-ionic surfactants; inorganic alkaline metal oxide or hydroxide mixture comprising: metal oxide or hydroxide; water as a solvent; suspension agents such as gum, x-gum, or thickeners; and surfactants such as polyacrylates. In an embodiment, a suitable commercially available product is x-gum, available from R.T. Vanderbilt (Norwalk, Connecticut). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2. In an embodiment, the concentration of the acid phosphate component in the inorganic acid phosphate mixture may be in the range 20-80%. In an embodiment, the concentration of the metal oxide or hydroxide component in the inorganic alkaline metal oxide or hydroxide mixture may be in the range 20-80%.

In an embodiment, the coating system may include inorganic acid phosphate mixture comprising: at least one acidic phosphate component; at least one filler selected from metal silicates, olivine, glass fiber, non-crystalline silica, or wollastonite; water as a solvent; suspension agents such as gum, x-gum, or thickeners; and non-ionic surfactants; inorganic alkaline metal oxide or hydroxide mixture comprising: metal oxide or hydroxide; at least one filler selected from metal silicates, olivine, glass fiber, non-crystalline silica, or wollastonite; water as a solvent; suspension agent such as gum, x-gum, or thickeners; and surfactant such as polyacrylates. In an embodiment, a suitable commercially available product is x-gum, available from R.T. Vanderbilt (Norwalk, Connecticut). In an embodiment, a suitable commercially available product is silica, available from Evonik (Essen, Germany). In an embodiment, a suitable commercially available product is filler available from Lintech International (Macon, Georgia). In an embodiment, filler may include a suitable commercially available product, which is microglass milled fibers available from Fibertec, Inc. (Bridgewater, MA). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2. In an embodiment, the concentration of the acid phosphate component in the inorganic acid phosphate mixture may be in the range 20-80%. In an embodiment, the concentration of the metal oxide or hydroxide component in the inorganic alkaline metal oxide or hydroxide mixture may be in the range 20-80%.

In an embodiment, the coasting system may include inorganic acid phosphate mixture comprising: 40-60 % mono potassium phosphate; 1-8 % phosphoric acid; 8-20 % of at least one filler selected from metal silicates, olivine, glass fiber, non-crystalline silica, or wollastonite; 10-20 % water; inorganic alkaline metal oxide or hydroxide mixture comprising: 25-50 % magnesium oxide or hydroxide; 10-25 % of at least one filler selected from metal silicates, olivine, glass fiber, non-crystalline silica, or wollastonite; 10-30 % water; 0-1 % of at least one suspension agent such as gum, x-gum, or thickeners. In an embodiment, a suitable commercially available product is X-gum, available from R.T. Vanderbilt (Norwalk, Connecticut). In an embodiment, a suitable commercially available product is phosphoric acid, available from ICL fertilizer (St. Louis, Missouri). In an embodiment, a suitable commercially available product is monopotassium phosphate, available from ICL fertilizer (St. Louis, Missouri). In an embodiment, a suitable commercially available product is silica available from Evonik (Essen, Germany). In an embodiment, a suitable commercially available product is filler available from Lintech International (Macon, Georgia). In an embodiment, filler may include a suitable commercially available product, which is microglass milled fibers available from Fibertec, Inc. (Bridgewater, MA).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2.

In an embodiment, the coating system may include inorganic acid phosphate mixture comprising: 40-60 % mono potassium phosphate; 8-20 % of at least one filler selected from metal silicates, olivine, glass fiber, non-crystalline silica, or wollastonite; 10-20 % water; inorganic alkaline metal oxide or hydroxide mixture comprising: 25-50 % magnesium oxide or hydroxide; 0-5 % of at least one filler selected from metal silicates, olivine, glass fiber, non-crystalline silica; 10-20 % wollastonite; 10-30 % water; 0-2 % surfactants such as polyacrylates; 0-1 % suspension agents such as gum, x-gum, or thickeners. In an embodiment, a suitable commercially available product is X-gum, available from R.T. Vanderbilt (Norwalk, Connecticut). In an embodiment, a suitable commercially available product is monopotassium phosphate, available from ICL fertilizer (St. Louis, Missouri). In an embodiment, a suitable commercially available product is silica, available from Evonik (Essen, Germany). In an embodiment, a suitable commercially available product is magnesium hydroxide, available from Timab (Dinard, France). In an embodiment, a suitable commercially available product is filler, available from Lintech International (Macon, Georgia). In an embodiment, filler may include a suitable commercially available product, which is microglass milled fibers available from Fibertec, Inc. (Bridgewater, MA). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment,, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2.

In an embodiment, the coating system may include inorganic acid phosphate mixture comprising: 5-15 % mono aluminum phosphate; 8-20 % of at least one filler selected from metal silicates, olivine, glass fiber, non-crystalline silica, or wollastonite; 10-20 % water; inorganic alkaline metal oxide or hydroxide mixture comprising: 25-50 % magnesium oxide or hydroxide; 0-5 % of at least one filler selected from metal silicates, olivine, glass fiber, non-crystalline silica; 10-20 % wollastonite; 10-30 % water; 0-2 % surfactant such as polyacrylates; 0-1 % suspension agent such as gum, x-gum, or thickeners. In an embodiment, a suitable commercially available product is x-gum, available from R.T. Vanderbilt (Norwalk, Connecticut). In an embodiment, a suitable commercially available product is silica, available from Evonik (Essen, Germany). In an embodiment, a suitable commercially available product is magnesium hydroxide, available from Timab (Dinard, France). In an embodiment, a suitable commercially available product is filler, available from Lintech International (Macon, Georgia). In an embodiment, filler may include a suitable commercially available product, which is microglass milled fibers available from Fibertec, Inc. (Bridgewater, MA). In an embodiment, a suitable commercially available product is surfactant, such as Darvan 7, available from R.T. Vanderbilt (Norwalk, Connecticut). In an embodiment, a suitable commercially available product is surfactant, such as DOWFAX 2a, available from Dow Chemical (Midland, Michigan).

In an embodiment, the inorganic acid phosphate mixture: inorganic alkaline metal oxide or hydroxide mixture may be combined in a ratio of 1:1. In an embodiment, the inorganic acid phosphate mixture: inorganic alkaline metal oxide or hydroxide mixture may be combined in a ratio of 2:1. In an embodiment, the inorganic acid phosphate mixture: inorganic alkaline metal oxide or hydroxide mixture may be combined in a ratio of 1:2.

In an embodiment, a polyaspartic top coat may be applied to the dry coated iron surface. In an embodiment, the polyaspartic top coat thisckness may be in the range of about 3 to about 6 millimeters. In an embodiment, the polyaspartic top coat may include polyaspartic resin. In an embodiment, a suitable commercially available product is Chem-Thane DCP available from IndMar Coatings Corp. (Wakefield, VA).

In an embodiment, the curing step may form a phosphate containing passivation layer chemically bound to the iron surface. In an embodiment, the curing step may form a ceramic layer when acid phosphate reacts with alkaline oxide, and acid phosphate reacts with the iron surface, such that the ceramic layer is chemically bonded to the iron surface.

In an embodiment, a coated metal article is provided and may include a bulk metal substrate; a polyaspartic top coat; a ceramic layer, and a passivation layer. In embodiments, the passivation layer is positioned between the bulk metal surface and the ceramic layer. In embodiments, the passivation layer may include an iron phosphate and a substantially amorphous silicate composition. In an embodiment, a polyaspartic top coat may include a suitable commercially available product, which may be Chem-Thane DCP available from IndMar Coatings Corp. (Wakefield, VA). In an embodiment, the passivation layer may be essentially non-porous. In an embodiment, the final pH of the coating may be provided in the passivation range of steel, for example, between about pH 9 and about pH 12. In the case of an iron substrate, for example, the composition of the passivation layer may comprise Mg, Si, P, S, K and Ca in a range of about 1% to about 12%, and iron about 45-80 weight percent. The remainder may be, for example, oxygen, hydrogen and trace elements. In an embodiment, a suitable commercially available product is silica, available from Evonik (Essen, Germany).

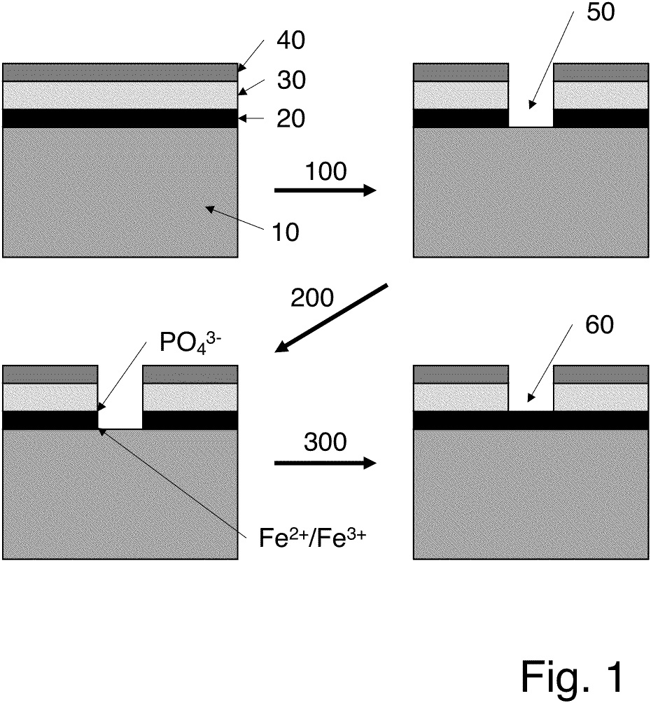

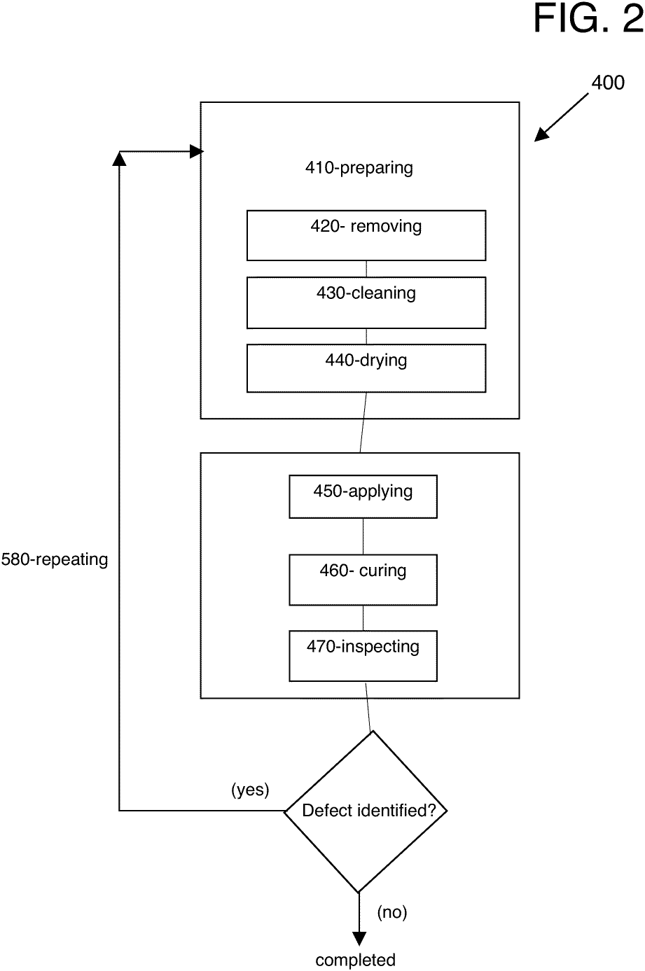

Referring to FIG. 1, a schematic of self-regeneration of the corrosion inhibiting layer is shown on a surface (10) of iron. The passivation layer (20) is right above the surface, followed by a ceramic layer (30). Finally, a top coat of polyaspartic resin (40) is above the ceramic layer. When the coating is applied the first time, defects may be formed (50). This is indicated by the process 100. Defects can be healed as phosphate ions and iron migrate to the defect (as indicated by step 200) and reform (60) the iron phosphate primer coating (40) (as indicated by step 300).

In embodiments, a corrosion resistant structural member is provided comprising a rigid inner structure comprising iron; and an outer coating resistant to corrosion. Such outer coating may be as elsewhere disclosed herein. In an embodiment, a polyaspartic top coat may include a suitable commercially available product, which may be Chem-Thane DCP available from IndMar Coatings Corp. (Wakefield, VA).

What is claimed is:

1-24. (canceled)

25. A method of providing corrosion protection to at least a portion of a metal surface containing iron, the metal surface susceptible to corrosion, to provide resistance to corrosion thereto, said method comprising:
sandblasting sheet pile to remove mill scale;
cleaning with water pressure washing;
drying with compressed air;
applying a coating system;
curing the metal surface with the coating system for more than about 1 hour;
inspecting the metal surface for defects;
repeating, if a defect is found, the sandblasting, cleaning, drying, applying, curing,
and inspecting.

26. The method of claim 25 comprising:
said coating system further comprising:
inorganic acid phosphate mixture comprising:
at least one acidic phosphate component;
water as a solvent;
a suspension agent selected from: gum, x-gum, and a thickener; and
a non-ionic surfactant;
inorganic alkaline metal oxide or hydroxide mixture comprising:
metal oxide or hydroxide;
water as a solvent;
a suspension agent selected from: gum, x-gum, and thickener; and
a surfactant selected from polyacrylates.

27. The method of claim 26, wherein, the inorganic acid phosphate mixture: inorganic alkaline metal oxide or hydroxide mixture is combined in a ratio of 1:1.

28. The method of claim 26, wherein, the inorganic acid phosphate mixture: inorganic alkaline metal oxide or hydroxide mixture is combined in a ratio of 2:1.

29. The method of claim 26, wherein, the inorganic acid phosphate mixture: inorganic alkaline metal oxide or hydroxide mixture is combined in a ratio of 1:2.

30. The method of claim 26 wherein, the concentration of the acid phosphate component in the inorganic acid phosphate mixture is in the range 20-80%.

31. The method of claim 26, wherein, the concentration of the metal oxide or hydroxide component in the inorganic alkaline metal oxide or hydroxide mixture is in the range 20-80%.

32. The method of claim 25 comprising:
said coating system further comprising:
inorganic acid phosphate mixture comprising:
at least one acidic phosphate component;
at least one filler selected from metal silicates, olivine, glass fiber, non-crystalline silica, and wollastonite;
water as a solvent;
a suspension agent selected from: gum, x-gum, and a thickener; and
a non-ionic surfactant;
inorganic alkaline metal oxide or hydroxide mixture comprising:
metal oxide or hydroxide;
at least one filler selected from metal silicates, olivine, glass fiber, non-crystalline silica, and wollastonite;
water as a solvent;
a suspension agent selected from: gum, x-gum, and a thickener; and
a surfactant selected from polyacrylates.

33-37. (canceled)

38. The method of claim 25 comprising:
said coating system further comprising:
inorganic acid phosphate mixture comprising:
40-60 % mono potassium phosphate;
1-8 % phosphoric acid;
8-20 % of at least one filler selected from metal silicates, olivine, glass fiber, non-crystalline silica, and wollastonite;
10-20 % water;
inorganic alkaline metal oxide or hydroxide mixture comprising:
25-50 % magnesium oxide or hydroxide;
10-25 % of at least one filler selected from metal silicates, olivine, glass fiber, non-crystalline silica, and wollastonite;
10-30 % water;
0-1 % of at least one suspension agent selected from: gum, x-gum, and a thickener.

39-49. (canceled)

50. The method of claim 25, wherein, a polyaspartic top coat is applied to the dry coated iron surface.

51. The method of claim 50, wherein, the polyaspartic top coat is 3-6 millimeters thick.

52. The method of claim 25 comprising:
said curing further comprises forming a phosphate containing passivation layer chemically bound to the metal surface containing iron.

53. The method of claim 25 comprising:
said curing further comprises forming a ceramic layer by acid phosphate reacting with alkaline oxide, and acid phosphate reacting with the metal surface containing iron, such that the ceramic layer is chemically bonded to the metal surface containing iron.

54-59. (canceled)
